(19) United States
(12) Patent Application Publication
(10) Pub. No.: US 2009/0146343 A1
(43) Pub. Date: Jun. 11, 2009

(54) Film Profile Forming Method

(76) Inventor: Yi Wen, Chongqing (CN)

Correspondence Address: HDLS Patent & Trademark Services, P.O. BOX 220746, CHANTILLY, VA, 20153-0746, US

(21) Appl. No.: 11/968,697

(22) Filed: Jan. 3, 2008

(30) Foreign Application Priority Data
Dec. 6, 2007 (TW) 096146436

(51) Int. Cl. B29C 51/08

(52) U.S. Cl. 264/325

(57) ABSTRACT

A film thermoforming method includes inserting a film prefabricated material need to be thermoformed into a lower die of a thermoforming device. The thermoforming device includes an upper die movable to-and-fro opposite to the lower die based on the shape of a film product. The upper die moves downwards gradually to press from a predetermined manufacturing height and then moves upwards to release the prefabricated material by a cycle mode, and the method decreases gradually the manufacturing height of the upper die for thermoforming the film product in a predetermined time. The present method can improve the precision and the quality of the film product, and can decrease largely the manufacturing time.

### 1. FIELD OF THE INVENTION

The present invention relates to a film thermoforming method, and more specifically, to a plastic film thermoforming method by in-mold labeling.

### 2. DESCRIPTION OF THE RELATED ART

For labeling on plastic products, a conventional method prints or sprays figures or words on the surfaces of the plastic products after performing the plastic products. However, there are many disadvantages. For example, the figures or the words are prone to be damaged by frequent contact since they are formed on the surfaces of the plastic products. Furthermore, it needs more time to be implemented.

An in-mold labeling (IML) technology is well known as an advanced method for labeling the figures or the words. A planar transparent plastic film material is prepared to form a three-dimensional transparent film, which is configured for combining with the plastic products. The three-dimensional transparent film has the figures or the words formed thereon. The three-dimensional transparent film is arranged in a mould, and hot plastic is injected into the mould to integrate the three-dimensional transparent film with the plastic product. Therefore, the technology can protect and display the figures or the words through the three-dimensional transparent film.

The key step of the in-mold labeling technology is obtaining the three-dimensional transparent film using the planar transparent film material. The key step may be achieved by a technology of matched metal forming, such as a thermoforming machine disclosed in a US Pat. Pub. No. 2007/0087072. The thermoforming machine employs a servo motor to drive a nut rotating through a strap. A screw and an upper plate, a supporting plate, an upper die formed thereon, are indirectly driven to move to and fro in a perpendicular direction, such that the upper die moves to and fro in a direction to close or far away a lower die for thermoforming singly and gradually the planar transparent film material arranged on the top of the lower die to mold the three-dimensional transparent film. However, since the film is made of the plastic material, the film will shrink in a direction opposite to a forming direction after the upper die moves far away the lower die to release the transparent film and during cooling the transparent film, such that the precision and the quality of the transparent film are difficult to be controlled.

What is needed is a film thermoforming method, which can solve the above problems.

### BRIEF SUMMARY

An object of the present invention is providing a film thermoforming method, which can solve the above problems.

A film thermoforming method, in accordance with a preferred embodiment of the present invention, includes inserting a film prefabricated material to be thermoformed into a lower die of a thermoforming device. The thermoforming device includes an upper die movable to-and-fro opposite to the lower die based on a shape of a film product.

The upper die moves downwards gradually to press from a predetermined manufacturing height and then moves upwards to release the prefabricated material by a cycle mode, and the method decreases gradually the manufacturing height of the upper die for thermoforming the film product in a predetermined time scope.

The present method can provide enough time to make the film prefabricated material partially plastic deform, for solving the problem of the film shrinking in a direction opposite to a forming direction during cooling the film product. Therefore, the present method can improve the precision and the quality of the film product, and can decrease largely the manufacturing time.

Preferably, a displacement distance unit of the upper die moving downwards to press the film prefabricated material is larger than a displacement distance unit of the upper die moving upwards to release the film prefabricated material.

a displacement time unit of the upper die moving downwards to press the film prefabricated material is more than, equal to or less than a displacement time unit of the upper die moving upwards to release the film prefabricated material.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, front view of an environment relating to a film thermoforming method, in accordance with a preferred embodiment of the present invention;

FIG. 2 is a schematic, using view of FIG. 1;

FIG. 2a is a schematic, part-enlarged view of FIG. 2;

FIG. 3 is another schematic, using status view of FIG. 1;

FIG. 4 is a displacement graph of an upper die of the present invention;

FIG. 5 is another displacement graph of the upper die of the present invention;

FIG. 6 is a schematic, using view of FIG. 2a;

FIG. 7 is another schematic, using view of FIG. 2a;

FIG. 8 is other schematic, using view of FIG. 2a; and

FIG. 9 is other schematic, using view of FIG. 1.

### DETAILED DESCRIPTION

Reference will now be made to the drawings to describe a preferred embodiment of the present film thermoforming method, in detail.

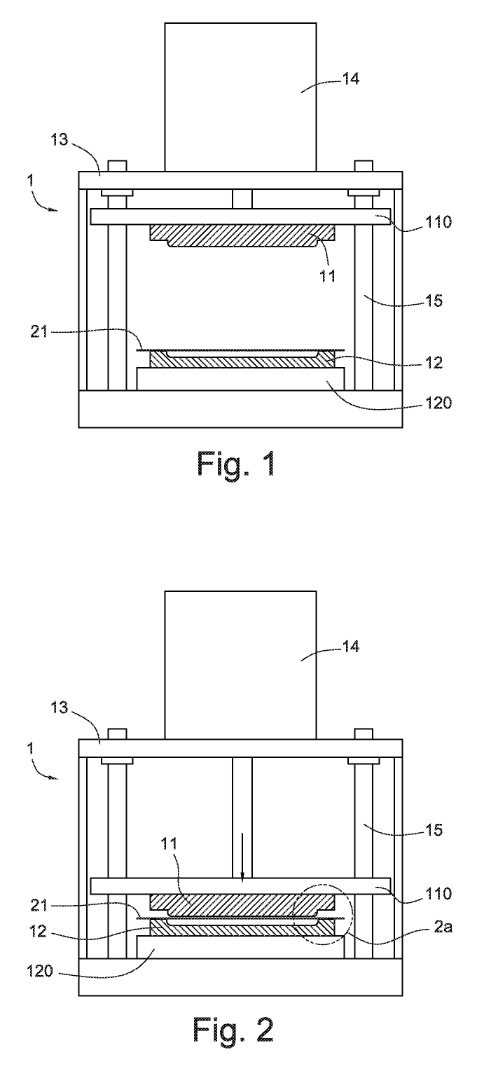

Referring to FIG. 1, a schematic, front view of an environment relating to a film thermoforming method, in accordance with a preferred embodiment of the present invention, is shown. The present film thermoforming method includes inserting a film prefabricated material 21, which need to be thermoformed, into a lower die 12 of a thermoforming device 1. The thermoforming device 1 further includes an upper die 11 movable to-and-fro (as shown in FIG. 3) opposite to the lower die 12 based on the shape of the product. In a detailed embodiment, the thermoforming device 1 further includes:

a supporting table 13;

a driving unit 14 arranged on the top of the supporting table 13;

a die set 120 arranged under the supporting table 13, and the lower die 12 arranged on the top of the die set 120;

a punch set 110 slidably arranged between the supporting table 13 and the die set 120 through a plurality of guiding poles 15, the punch set 110 being driven by the driving unit 14 to move to-and-fro in a perpendicular direction to close to or far away from the die set 120, and the upper die 11 being arranged on the bottom of the punch set 110.

The present film thermoforming method may be performed in the above environment.

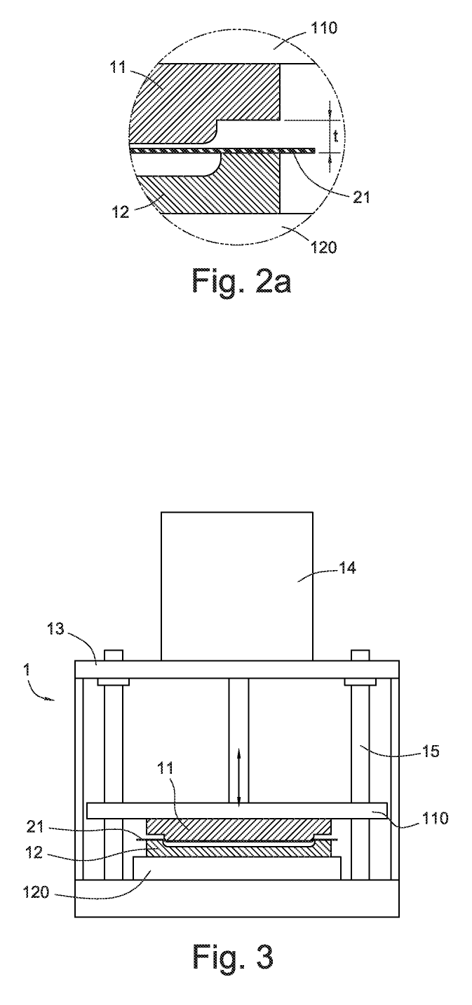

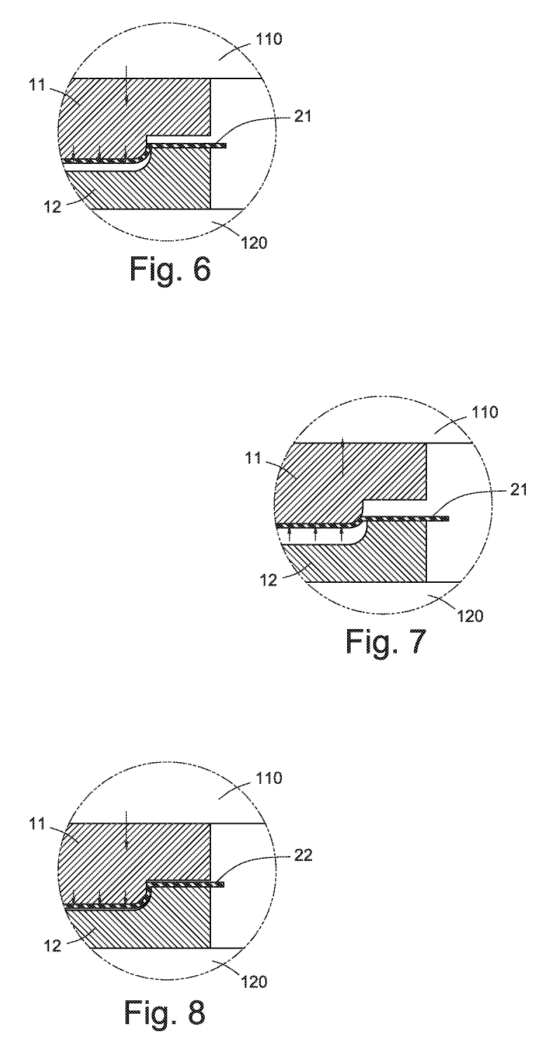

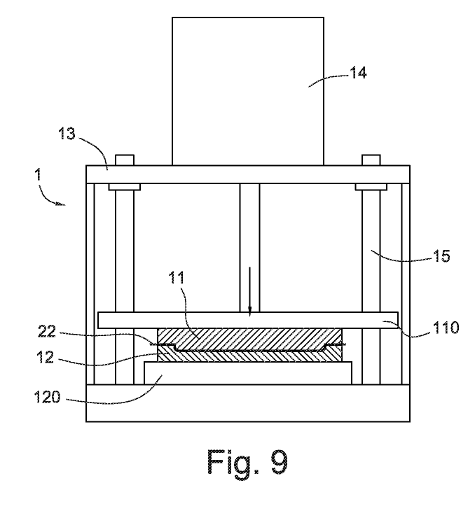

The upper die 11 moves downwards gradually to press (as shown in FIG. 6) from a predetermined manufacturing height t (as shown in FIGS. 2 and 2a), and then moves upwards (as shown in FIG. 7) to release the prefabricated material 21 by a cycle mode (as shown in FIG. 8). And the thermoforming method decreases gradually the manufacturing height of the upper die 11 for thermoforming a film product 22 (as shown in FIG. 9) in a predetermined time scope.

The predetermined time scope is an operating time for the upper die 11 operating the film prefabricated material 21. The manufacturing height is a distance between the upper die 11 and the lower die 12. The upper die 11 moves downwards to press the film prefabricated material 21 (as shown in FIGS. 6 and 8), such that the film prefabricated material 21 is peremptorily deformed. The upper die 11 then moves upwards to release the film prefabricated material 21 (as shown in FIG. 7) after pressing the film prefabricated material 21, such that the film prefabricated material 21 can extend to finalize the shape, and then the upper die 11 moves downwards to press the film prefabricated material 21 again.

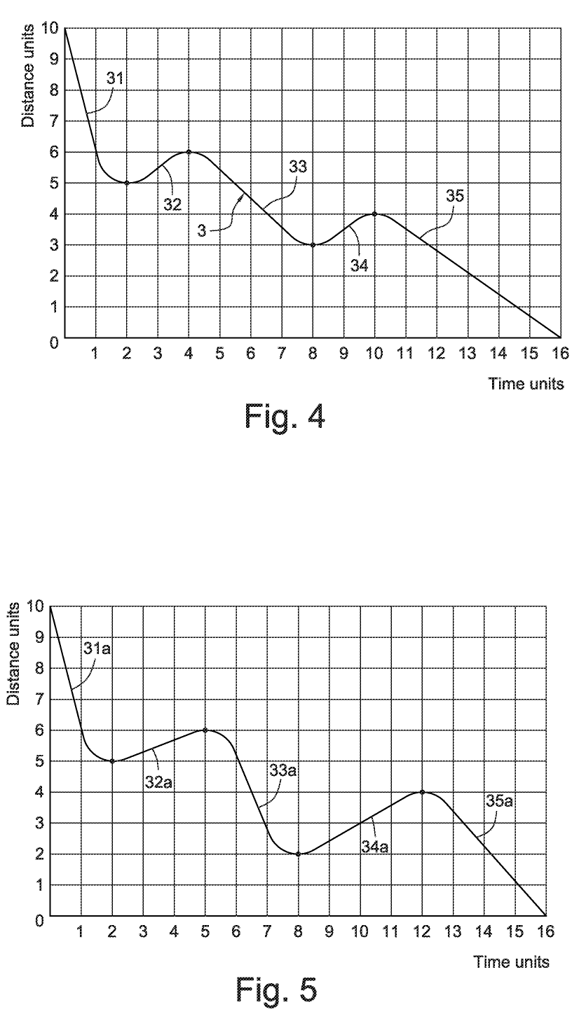

Referring to FIG. 4, a graph, which shows that the upper die 11 moves downwards gradually to press and moves upwards to release the film prefabricated material 21 by the cycle mode, is shown. In this embodiment, the predetermined time scope may be equal to or less than 16 time units. The manufacturing height of the upper die 11 may be equal to or less than 10 distance units, and the predetermined manufacturing height t is the tenth distance unit. The displacement curved line 3 of the film prefabricated material 21 starts from the tenth distance unit, and includes a first pressing displacement route 31, a first releasing displacement route 32, a second pressing displacement route 33, a second releasing displacement route 34, and a third pressing displacement route 35. The film prefabricated material 21 is manufactured to form the film product 22 after the upper die 11 performing the third pressing displacement route 35.

Each of the displacement route units 31, 33, 35 (as shown in FIG. 4), in which the upper die 11 moves downwards to press the film prefabricated material 21, is larger than any one of the displacement routes 32, 34, in which the upper die 11 moves upwards to release the film prefabricated material 21. That is, displacement distance units of the displacement route units 31, 33, 35 are all larger than displacement distances units of the displacement route units 32, 34.

Each displacement time unit of the displacement routes 31, 33, 35, in which the upper die 11 moves downwards to press the film prefabricated material 21, is more than or equal to that of any displacement time unit of the displacement routes 32, 34, in which the upper die 11 moves upwards to release the film prefabricated material 21 (as shown in FIG. 4).

Referring to FIG. 5, still another graph, which shows that the upper die 11 moves downwards gradually to press and moves upwards to release the film prefabricated material 21 by the cycle mode, is shown. In this embodiment, each displacement time unit of the displacement routes 31a, 33a, 35a, in which the upper die 11 moves downwards to press the film prefabricated material 21, is less than that of any displacement time unit of the displacement routes 32a, 34a, in which the upper die 11 moves upwards to release the film prefabricated material 21 (as shown in FIG. 4).

From the above, the present method makes the upper die 11 gradually hot presses and release the film prefabricated material 21, such that the film prefabricated material 21 gradually bends, deforms and extends to finalize the shape. The present method can provide enough time to make the film prefabricated material 21 partially plastic deform, and then to improve the precision and the quality of the film product and decrease largely the manufacturing time.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A film thermoforming method, comprising:
inserting a film prefabricated material to be thermoformed into a lower die of a thermoforming device, the thermoforming device including an upper die linearly movable to-and-fro opposite to the lower die based on a shape of a film product,
wherein the upper die moves downwards gradually to press from a predetermined manufacturing height and then moves upwards to release the prefabricated material by a cycle mode, and the method decreases gradually the manufacturing height of the upper die for thermoforming the film product in a predetermined time scope.

2. The method as claimed in claim 1, wherein a displacement distance unit of the upper die moving downwards to press the film prefabricated material is larger than a displacement distance unit of the upper die moving upwards to release the film prefabricated material.

3. The method as claimed in claim 1, wherein a displacement time unit of the upper die moving downwards to press the film prefabricated material is more than or equal to a displacement time unit of the upper die moving upwards to release the film prefabricated material.

4. The method as claimed in claim 1, wherein a displacement time unit of the upper die moving downwards to press the film prefabricated material is less than a displacement time unit of the upper die moving upwards to release the film prefabricated material.
